(19) United States
(12) Patent Application Publication
(10) Pub. No.: US 2014/0031618 A1
(43) Pub. Date: Jan. 30, 2014

(54) DECORATIVE SLEEVE FOR VIBRATORS AND/OR DILDOS

(71) Applicant: Sally Lomax Mallett, Houston, TX (US)

(72) Inventor: Sally Lomax Mallett, Houston, TX (US)

(21) Appl. No.: 13/952,560

(22) Filed: Jul. 26, 2013

Related U.S. Application Data
(60) Provisional application No. 61/676,183, filed on Jul. 26, 2012.

(51) Int. Cl. A61H 19/00

(52) U.S. Cl. CPC A61H 19/44
USPC 600/38; 428/34.1

(57) ABSTRACT

A decorative sleeve disclosed, for use with a vibrator, a dildo, or other phallic sex toy device. The decorative sleeve includes an attachment portion and a decorative portion. The attachment portion consists of either a stretchy piece of fabric, a pair of connectable straps, or both, for securely connecting the decorative portion to the device. The decorative portion consists fabric arranged in a variety of configurations, used to “dress up” the device, as if dressing a doll.

### CROSS-REFERENCE TO RELATED APPLICATIONS

This application claims priority to U.S. Provisional Patent Application No. 61/676,183, filed on Jul. 26, 2012, the entire contents of which are hereby incorporated by reference as if fully set forth herein.

### TECHNICAL FIELD

This application relates to vibrators, dildos and other products for the sex toy industry.

### BRIEF DESCRIPTION OF THE DRAWINGS

The foregoing aspects and many of the attendant advantages of this document will become more readily appreciated as the same becomes better understood by reference to the following detailed description, when taken in conjunction with the accompanying drawings, wherein like reference numerals refer to like parts throughout the various views, unless otherwise specified.

FIG. 1 is a depiction of a decorative sleeve disposed upon a dildo, according to some embodiments;

FIG. 2 is a depiction of a second decorative sleeve disposed upon a vibrator, according to some embodiments;

FIG. 3 is a simplified drawing of the attachment portion of the decorative sleeve of FIGS. 1 and 2, according to some embodiments;

FIG. 4 is a rear view of the second decorative sleeve of FIG. 2, according to some embodiments;

FIG. 5 is a side view of the second decorative sleeve of FIG. 2, according to some embodiments; and

FIG. 6 is a view of the second decorative sleeve, not disposed upon a phallic device, used to illustrate the attachment portion, according to some embodiments.

### DETAILED DESCRIPTION

In accordance with the embodiments described herein, a decorative sleeve is disclosed, for use with a vibrator, a dildo, or other phallic sex toy device. The decorative sleeve includes an attachment portion and a decorative portion. The attachment portion consists of either a stretchy piece of fabric, one or multiple connectable straps, or both, for securely connecting the decorative portion to the device. The decorative portion consists fabric arranged in a variety of configurations, used to “dress up” the device. The decorative portion may “animate” the phallic device, as if dressing a doll, or may decorate in an inanimate fashion, such as might be used in a centerpiece.

In the following detailed description, reference is made to the accompanying drawings, which show by way of illustration specific embodiments in which the subject matter described herein may be practiced. However, it is to be understood that other embodiments will become apparent to those of ordinary skill in the art upon reading this disclosure. The following detailed description is, therefore, not to be construed in a limiting sense, as the scope of the subject matter is defined by the claims.

Before describing the decorative sleeve in detail, some terms that are used herein are defined. A dildo is defined herein as a non-vibrating toy (no power source) that often assumes a phallic (penis) shape. A vibrator is defined herein as a vibrating toy (usually has a power source). While many vibrators are phallic in shape, vibrators may assume other configurations and shapes. Dildos often emulate the human phallus while vibrators are less likely to do so. The decorative sleeve is most appropriate for phallic-shaped vibrators or dildos. Both vibrators and dildos are referred to herein as “phallic devices,” are among a large variety of devices deemed “sex toys,” and generally encompass the realm of adult entertainment relating to sexual activity. Specific use of these sex toys is beyond the scope of this disclosure and is thus left to the imagination and further research of the reader.

Dildos and vibrators are made from a variety of materials, in many different colors and many different shapes. Typically, dildos are made from softer, elastomeric or plastic materials while vibrators feature more rigid materials. Vibrators are known to be made of hard plastic, aluminum, wood, and ceramic, while dildos are more often designed to emulate the feel of real skin as much as possible, with materials like silicon, jelly, cyberskin, futurotic, softskin, or other soft-touch materials being used.

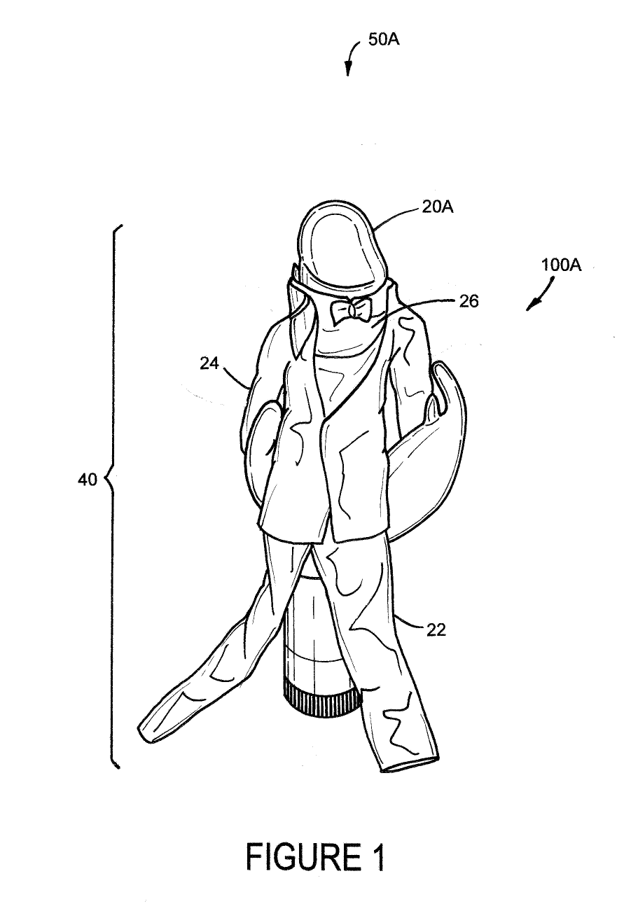

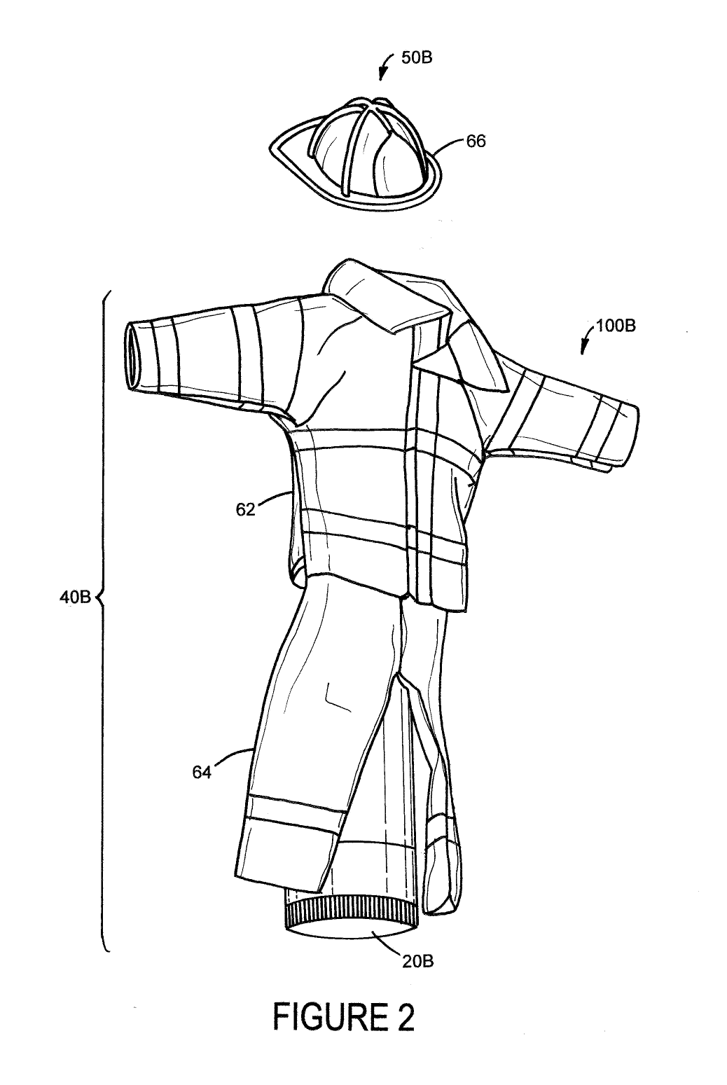

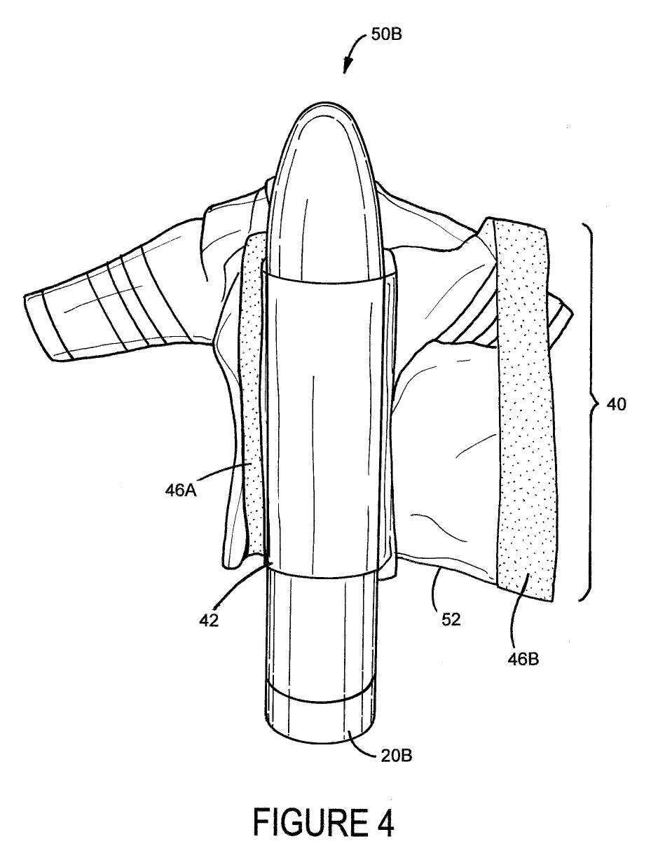

With reference to FIGS. 1-6, two embodiments of a decorated sex toy are depicted, sex toy 50A (FIG. 1) and sex toy 50B (FIG. 2, as well as FIGS. 4-6) (collectively, “sex toys 50”). The sex toy 50A (FIG. 1) consists of a decorative sleeve 100A disposed upon a dildo 20A, according to some embodiments. The sex toy 50B (FIG. 2) also consists of a decorative sleeve 100B disposed upon a vibrator 20B (collectively, “decorative sleeve 100” or “decorative sleeves 100”). Collectively, the dildo 20A and vibrator 20B are known herein as phallic devices 20. Both decorative sleeves 100A and 100B are designed for use with dildos of other sizes and shapes, as well as vibrators or other phallic-shaped sex toys not depicted herein.

With reference to the sex toy 50A (FIG. 1), the decorative sleeve 100A consists of an attachment portion 30 (not shown) and a decorative portion 40. In the front-view depictions of the decorative sleeves 100, the attachment portion is, by design, hidden from view while the decorative portion is visible. The attachment portion 30 is used to connect the decorative sleeve 100 to the phallic device 20. The decorative portion 40 may be called a “men's formal wear” look, consisting of a silk shirt with red bowtie 26, a silk jacket 24, and silk pants 22.

The attachment portion 30 is secured to the decorative portion 40 in such a way so as to give the appearance that the phallic device 20 is “wearing” the decorative portion, in this example, “men's formal wear.” In the example decorative sleeve 100A, because the “men's formal wear” consists of high-collar items (the silk shirt 26 and silk jacket 24), such an appearance is achieved by sewing the attachment portion 30 securely at the top to the decorative portion 40 (and preferably using a material that is similar in quality and color), thus creating the illusion that the collar is slid over the phallic device 20, not just adjacent to the front of the device, as is technically the case.

The sex toy 50B (FIG. 2) consists of the vibrator 20B upon which the decorative sleeve 100B is attached. Again, the attachment portion 30 is not visible from this front-view depiction. Here, the decorative portion 40 may be called “fireman” and consists of a striped jacket 62 and striped utility pants 64. In some embodiments, the sex toy 50B further includes a hat 66 (a “fireman's hat”), used to complete the “look” of a fireman. In some embodiments, the hat 66 includes a stretchy band of fabric, tubular in shape, lining the inside of the hat so as to allow the hat to fit snugly around the tip of the phallic device 20.

The decorative sleeves 100 may be interchanged. The “men's formal wear” decorative sleeve 100A may be disposed upon the vibrator 20B while the “fireman” decorative sleeve 100B may be disposed upon the dildo 20A. Furthermore, these decorative sleeves 100 may be attached to other sex toy devices that assume phallic shapes, as well as devices that do not necessarily reference a phallus.

In some embodiments, the decorative sleeves 100 are adornments used to animate the phallic device 20, so as to “dress up” the device, as if dressing up a doll. To animate the phallic device 20, the decorative portion 40 may consist of “theme” outfits, such as “cowboy”, “fireman”, “policeman”, “fairy princess”, “disco dancer”, “super hero”, etc., holiday outfits, such as “Santa Claus”, “Easter rabbit”, “wicked witch”, etc. In other embodiments, the decorative sleeves 100 represent inanimate adornments, such as bows, stars, numbers, and other elements, such as may be used to adorn a centerpiece.

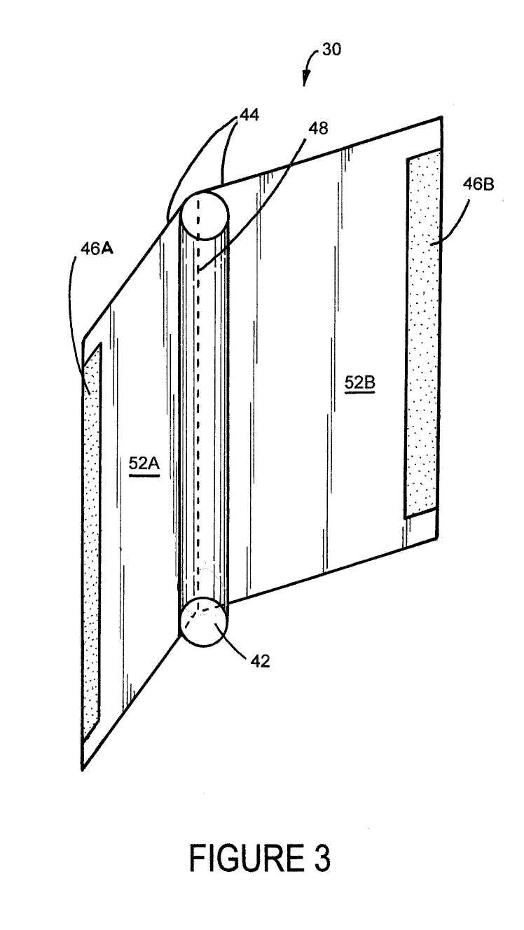

FIG. 3 is a simplified diagram of the attachment portion 30 of the decorative sleeve 100, according to some embodiments. The attachment portion 30 preferably consists of both a slide-on portion 42 and a securing portion 44, although the decorative sleeve 100 may consist of either the slide-on portion or the securing portion. The slide-on portion 42 is a single piece of fabric, preferably of a stretch variety, that is sewn into a cylindrical shape, one side of which is looped over the phallic device 20 such that the slide-on portion surrounds a significant portion of the phallic shape, in some embodiments. The slide-on portion 42 is connected to the securing portion 44 by a seam 48.

In some embodiments, the securing portion 44 consists of two side panels 52A and 52B (collectively, “side panels 52”). The side panels 52A and 52B may, in fact, consist of a single piece of rectangular fabric having a left side (52A) and a right size (52B). In some embodiments, the side panel 52A is shorter than the side panel 52B. In other embodiments, the side panels 52A and 52B are the same length. In either case, the length of the side panels is sized according to the circumference of the phallic device 20.

Side panel 52A consists of an adhesive strip 46A disposed at its distal end, where the proximate end of the side panel attaches to the seam 48. In some embodiments, the adhesive strip 46A is disposed on the back side of the side panel 52A. Likewise, side panel 52B consists of an adhesive strip 46B disposed at the distal end of the side panel. Here, the adhesive strip 46B is disposed on the front side of the side panel 52B. Where the side panels 52 consist of a single piece of fabric, the adhesive strips 42 are thus disposed on opposing surfaces of the fabric. Thus, when the side panel 52A is wrapped around the phallic device 20, the backside of the adhesive portion 46A is positioned toward the front of the slide-on portion 42. Likewise, when the side panel 52B is wrapped around the phallic device 20, the frontside of the adhesive portion 46A is able to mate with the adhesive portion 46A such that the adhesive strips fixably mate with one another.

The adhesive strips 46A and 46B (collectively, “adhesive strips 46”) are intended to mate with one another and adhese the attachment portion 30 securely to the phallic device 20. Further, the side panels 52 are sized such that attachment of the adhesive strips 46 causes the attachment portion 30 to be snug against the phallic device 20.

The adhesive strips 46 may be composed of any number of different materials suitable for attachment, removal, and reattachment. Preferably, single-use adhesive strips are not used. Rather, in a preferred embodiment, the adhesive strips 46 consist of Velcro™ strips. Velcro is a product consisting of a hook and loop fastener consisting of two thin strips of plastic sheet, one strip covered with tiny loops and the other strip covered with tiny flexible hooks.

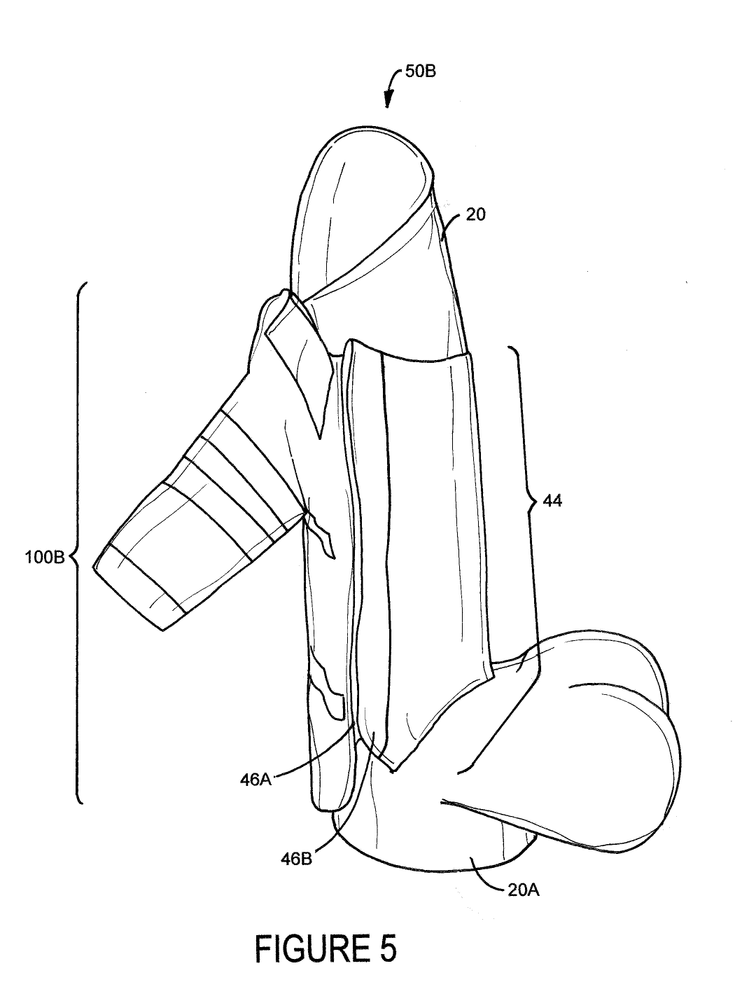

FIGS. 4 and 5, depicting rear and side views, respectively, of the sex toy 50B, feature the attachment portion 30, in some embodiments. In the rear view of the sex toy 50B (FIG. 4), the attachment portion 30 consists of the slide-on portion 42 and the securing portion 44. The slide-on portion 42 consists of a tube or cylinder of fabric to be slid down over the top of the phallic device 20, while the securing portion 44 consists of the two side panels 52 (only side panel 52B is visible in FIG. 4) and connectors 46. In this example, the adhesive portions 46 are Velcro connectors, which may be secured (mated) together, pulled apart, and repeatedly resecured and pulled apart, without diminution of their adhesive capability.

In the rear view of the sex toy 50B, the slide-on portion 42 of the attachment portion 30 is disposed over the phallic device 20, as designed for presentation of the decorative portion 40 (the backside of which is partially visible in back of the phallic device), which is secured to the attachment portion.

In FIG. 4, the securing portion 44 is unfurled. The side view of the sex toy 50B (FIG. 5), however, shows the securing portion 44 of the sleeve 30 in its closed position, with the two opposing strips of Velcro 46A and 46B engaged with one another. In the embodiment of FIG. 5, the decorative sleeve 100B has no slide-on portion 42.

In some embodiments, the decorative sleeves 100 are manufactured in different sizes, with the attachment portion 30 and the decorative portion 40 being made in different colors in the form of “costumes”, so as to decorate the phallic device 20. The decorative portion 40 is thus sized in relation to the size of the phallic device 20. Where the decorative portion 40 “animates” the phallic device 20, the height of the decorative portion 40 is close to the length of the phallic device where the device is to be fully clothed, as in the case of the “men's formal wear” and “fireman” costumes depicted thus far. Where the outfit is a “school girl” or “cheerleader”, the size of the decorative portion 40 may be shorter, such as to convey an impression that the phallic device 20 is “wearing” a mini-skirt. Clothing designers of ordinary skill in the art are capable of designing and producing clothing wear suitable to the size of the object, so as to “animate” the object by giving the impression that the object is “wearing” the outfit. The decorative sleeves 100 thus constitute a line of apparel for the adult toy market, specifically for phallic devices 20.

In some embodiments, the decorative sleeve 100 is a novelty gift item having several benefits. The decorative sleeve will cover, protect, and decorate the phallic device 20. Returning to FIG. 3, in some embodiments, the cylindrically shaped slide-on portion consists of an inside surface 90. In some embodiments, the inside surface 90 of the decorative sleeve 100 is made using antibacterial- and mildew-resistant fabric, thus providing a way to keep the device clean and disinfected while not in use. In some embodiments, some or all of the attachment portion 30 of the decorative sleeve 100 consists of antibacterial and mildew resistant material while the decorative portion 40 does not.

Depending on the size of the phallic device 20, the size of the attachment portion 30 may vary. In some embodiments, the color will also vary, so that the color of the attachment portion 30 matches the color of the decorative portion 40. In one example, the average size of a vibrator is 6½″ (insertable length)×1½″ in diameter; 8″ (includes base) the attachment portion 30 would preferably be approximately five inches in length and approx 1¾ in diameter in order to wrap snugly around the phallic device 20.

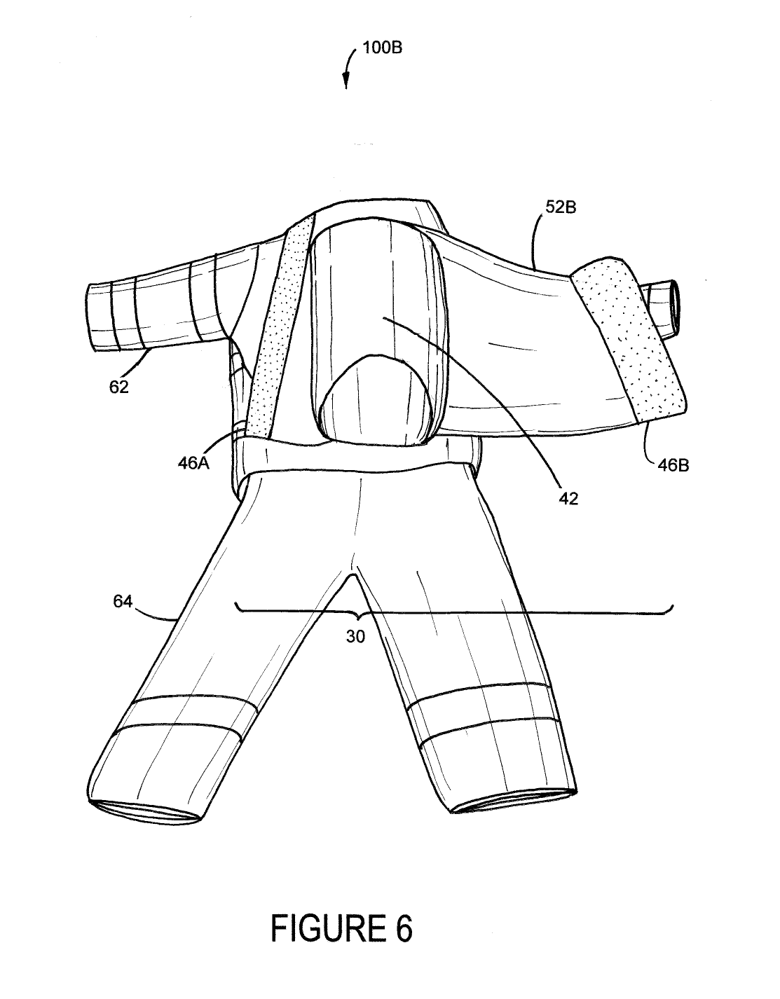

In some embodiments, the attachment portion 30 is attached to the backside of the decorative portion 40. FIG. 6 shows the decorative sleeve 100B of FIGS. 2, 4, and 5, with the decorative portion 40 lying flat on a surface, and the attachment portion 30 being visible atop the decorative portion. The attachment portion 30 clearly shows the slide-on portion 42, which is cylindrical in shape, and the securing portion 44, which features the side panels 52 and Velcro adhesive portions 46.

The decorative sleeve 100 may be manufactured in different ways, depending on the type of the material used. In one example, the attachment portion 30 of the decorative sleeve 100 consists merely of the slide-on portion 42, such as a single piece of stretchy fabric sewn into a cylindrical shape, for attaching to the phallic device 20. In this example, a user would simply slide the attachment portion 30 over the phallic device 20. In another example, the attachment portion 30 of the decorative sleeve 100 consists merely of the securing portion 44, with either two panels 52 having adhesive portions 46 to be coupled together or a single rectangular piece having adhesive portions on opposing sides, as described above. It is possible that the attachment portion 30 of the decorative sleeve 100 includes both the slide-on portion 42 (stretchy, cylindrical fabric piece) and the attachment portion (with removably connectable adhesive strips).

For example, where used on a vibrator, the decorative sleeve 100 may be attached by sliding the securing portion 44 over the vibrator without having to open the Velcro strap. This is possible because the vibrator is very smooth and thus enables a fabric material to readily slide over its surface. For a dildo made from silicon or other elastomeric material, on the other hand, the securing portion 44 of the attachment portion 30 is preferably opened and then wrapped around the dildo, possibly leaving the slide-on portion 42 unused. This will give the consumer the option to use the decorative sleeve 100 with either a smooth-surfaced or rough-surfaced phallic device 20.

In some embodiments, the decorative sleeve 100 is available along with a bag for storing the decorative sleeve and/or the phallic device 20. Although the bag may come in a variety of shapes and sizes, the bag is approximately eight inches wide and fourteen inches long in a preferred embodiment. In some embodiments, the bag has a zipper closure with a combination lock, and the lining of the bag is both antibacterial and mildew-resistant. The bag protects, sanitizes, and keeps the decorative sleeve 100 out of children's reach. The bag thus allows the consumer to discreetly hide and, at the same time, sanitize and protect the sex toys.

While the application has been described with respect to a limited number of embodiments, those skilled in the art will appreciate numerous modifications and variations therefrom. It is intended that the appended claims cover all such modifications and variations as fall within the true spirit and scope of the invention.

I claim:

1. A decorative sleeve to adorn a phallic device, the decorative sleeve comprising:
a decorative portion comprising an adornment such that the adornment is coupled to the phallic device; and
an attachment portion comprising a slide-on portion, wherein the slide-on portion is disposed over one end of the phallic device such that the decorative portion is adjacent to the phallic device.

2. The decorative sleeve of claim 1, the attachment portion further comprising a securing portion, wherein the securing portion adjustably secures the decorative portion to be adjacent to the phallic device.

3. The decorative sleeve of claim 2, the securing portion further comprising:
a rectangular portion;
a first adhesive strip secured to one side of the rectangular portion; and
a second adhesive strip, secured to an opposing side of the rectangular portion; and
a seam coupling the rectangular portion to the decorative portion;
wherein the rectangular portion is wrapped around the phallic device and the first adhesive strip is removably attached to the second adhesive strip, thus adjustably securing the decorative portion to be adjacent to the phallic device.

4. The decorative sleeve of claim 3, wherein the first adhesive strip and the second adhesive strip comprise opposing Velcro strips, wherein the opposing Velcro strips are removably attachable to one another.

5. The decorative sleeve of claim 3, the rectangular portion further comprising:
a first side panel and a second side panel;
wherein the first adhesive strip is secured to one side of the first side panel and the second adhesive strip is secured to an opposing side of the second side panel.

6. The decorative sleeve of claim 1, wherein the slide-on portion comprises an inside surface, wherein the inside surface is made using an anti-bacterial material.

7. The decorative sleeve of claim 6, wherein the inside surface further comprises a mildew-resistant material.

8. The decorative sleeve of claim 1, wherein the adornment is a predetermined size, the predetermined size being related to a length of the phallic device.

9. The decorative sleeve of claim 1, wherein the adornment comprises an outfit of clothing.

10. The decorative sleeve of claim 9, further comprising a hat, wherein the hat is associated with the outfit.

11. The decorative sleeve of claim 9, wherein the outfit is theme-based.

12. A decorated sex toy, comprising:
a phallic device;
a decorative sleeve to be disposed upon the phallic device, the decorative sleeve comprising:
a decorative portion comprising an outfit to be coupled to the phallic device; and
an attachment portion comprising either a slide-on portion, a securing portion, or both the slide-on portion and the securing portion, the attachment portion to couple the decorative sleeve against the phallic device.

13. The decorated sex toy of claim 12, wherein the attachment portion comprises the securing portion, the securing portion further comprising:
a first side panel and a second side panel;
a first adhesive strip secured to a distal end of the first side panel; and
a second adhesive strip secured to a distal end of the second side panel;
wherein the first side panel and second side panel are wrapped around the phallic device and the first adhesive strip is removably coupled to the second adhesive strip such that the decorative portion of the decorative sleeve is adjacent to the phallic device.

14. The decorated sex toy of claim 13, wherein the decorative portion animates the phallic device.

15. The decorated sex toy of claim 14, wherein the decorative portion is selected from a group consisting of:
super hero, men's formal wear, women's formal wear, fireman, policeman, school teacher, cheerleader, librarian, bride, bride's maid, groomsman, school girl, baby doll, cowboy, fairy princess, mermaid, disco dancer, Santa Claus, Easter rabbit, and wicked witch.

16. The decorative sleeve of claim 13, wherein the decorative portion does not animate the phallic device.

17. The decorative sleeve of claim 16, wherein the decorative portion is selected from a group consisting of:
bow, star, flower, flower bouquet, whistle, firecracker, number, numbers, symbol, flower, flag, cross, pentagon, pentagram, and peace sign.
